(19) United States
(12) Patent Application Publication
(10) Pub. No.: US 2006/0164539 A1
(43) Pub. Date: Jul. 27, 2006

(54) Camera module, camera system and method of manufacturing a camera module

(75) Inventors: Anton Petrus Maria Van Arendonk, Eindhoven (NL); Nicolaas Johannes Anthonius Van Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips electronics N.V., Eindhoven (NL)

(21) Appl. No.: 10/521,250

(22) PCT Filed: Jul. 11, 2003
(86) PCT No.: PCT/IB03/03153

§ 371 Date: Jan. 13, 2005

(30) Foreign Application Priority Data
Jul. 18, 2002 (EP) 02078113.4

(51) Int. Cl. H04N 5/225

(52) U.S. Cl. 348/340

(57) ABSTRACT

The invention relates to a camera module comprising a holder having a first end arranged for receiving light and a second end arranged for placing an image pickup module for picking up images. The camera module further comprises a lens or a system of lenses, having an optical axis arranged for forming an image on the image pickup module. Near the second end, the holder comprises means for aligning the image pickup module in a plane perpendicular to be optical axis. The aligning means are for instance formed by a recess in the inner wall of the holder near the second end. The image pickup module is placed within the recess substantially without play. This method of aligning the image pickup module simplifies the manufacture of the camera module.

The invention relates to a camera module comprising a holder having a first end arranged for receiving incident light, a second end arranged for placing an image pickup module for picking up images, and a lens having an optical axis arranged for forming an image on the image pickup module.

The invention also relates to a camera system comprising a camera module.

The invention furthermore relates to a method of manufacturing a camera module comprising a holder having a first end arranged for receiving incident light, a second end arranged for placing an image pickup module for picking up images, and a lens having an optical axis arranged for forming an image on the image pickup module.

Such a camera module is known from European patent application EP-A 1 081 944. The known camera module is suitable for use in a camera system, such as a camera system incorporated in a telephone, in a portable computer or in a digital photo or video camera. With the known camera module, an image pickup module is placed into abutment with the second end of the holder. The image pickup module of the known camera module comprises a substrate. Present on the side of the substrate facing away from the holder, on which an electrically conductive wiring pattern has been formed, is a solid-state image sensor, for example a CCD (Charge Coupled Device) image sensor or a CMOS (Complementary Metal Oxide Semiconductor) image sensor. The solid-state image sensor is electrically connected to further electronics in a camera system of which the camera module forms part by means of electrically conductive connections, for example in the form of bumps of a suitably selected material, such as gold or another electrically conductive material. One side of the solid-state image sensor facing towards the substrate comprises a light-sensitive area arranged for converting incident light into electrical signals.

In one embodiment of the known camera module, the substrate consists of a non-transparent material, for example a metal plate covered with a flexible foil on which said wiring pattern is present, in which plate an aperture is present for transmitting light to the light-sensitive area of the solid-state image sensor. In another embodiment, the substrate consists of a light-transmitting material, such as glass, on which a conductive wiring pattern is present on the side facing towards the solid-state image sensor.

One drawback of the known camera module is the fact that it requires a complicated manufacturing method, which renders the camera module relatively costly.

It is an object of the invention to provide a camera module which is simpler to manufacture. This object is achieved with a camera module according to the introductory paragraph, which is characterized in that the holder comprises aligning means near the second thereof for aligning the image pickup module in a plane perpendicular to the optical axis of the lens.

The position of the image pickup module with respect to the holder and thus to the lens has been precisely determined, using the aligning means, prior to the placing of the image pickup module in the holder. As a result, only one or a few possible ways of placing the image pickup module remain. The alignment of the image pickup module with respect to the lens is simplified in this way. This in turn results in a simplification of the manufacture of the camera module.

One embodiment of the camera module according to the invention is characterized in that the aligning means provide at least one recess near the second end, which recess extends parallel to a plane perpendicular to the optical axis and which is arranged for receiving the image pickup module substantially without play in a direction perpendicular to the optical axis.

Generally, the holder will be made of a plastic or other suitable material in the case of production in large numbers. With known methods of manufacturing the holder it is relatively simple to form recesses in the wall of the holder with sufficient precision. Aligning means in the form of recesses formed in the wall of the holder can be realized in a simple manner and with sufficient precision, therefore.

Another embodiment of the camera module according to the invention is characterized in that the recess has an opening via which the image pickup module can be placed in the recess from a direction parallel to the optical axis. Providing the recess with such an opening makes it easier to place the image pickup module in the holder substantially without play in a direction perpendicular to the optical axis. This leads to a further simplification of the manufacture of the camera module. An additional effect that is achieved with this embodiment is that it is also possible in this way to reduce the height of the camera module, the dimension in a direction parallel to the optical axis. This is advantageous in particular in the case of applications in which small dimensions are important, as is for example the case with telephones.

Another embodiment of the camera module according to the invention is characterized in that the recess has a lateral opening via which the image pickup module can be placed in the recess from a direction parallel to the optical axis.

Providing the recess with such an opening makes it easier to place the image pickup module in the holder substantially without play in a direction perpendicular to the optical axis. An additional advantage is that it is also possible in this way to place the image pickup module in the holder substantially without play in a direction parallel to the optical axis.

A camera system according to the invention is characterized in that it comprises a camera module according to the invention.

One advantage of the camera system according to the invention is the lower cost price. This cost price benefit is achieved as a result of the simplified manufacture of the camera module. This is an important aspect, for example, in the case of camera systems which are produced in large numbers for use in consumer products, such as mobile telephones.

A method of manufacturing a camera module comprising a holder having a first end arranged for receiving incident light, a second end arranged for placing an image pickup module for picking up images and a lens having an optical axis arranged for forming an image on the image pickup module, is characterized in that the method comprises a step in which the image pickup module is aligned with respect to the optical means in a direction perpendicular to the optical axis, using aligning means disposed near said second end. One advantage of the method according to the invention is that it is simpler than a known method of manufacturing a camera module. This simplification makes it possible to achieve a cost price benefit. This is an important aspect, for example, in the case of camera modules intended for use in camera systems in consumer products, such as mobile telephones.

These and other aspects of the invention will be explained in more detail hereinafter with reference to the drawings, in which:

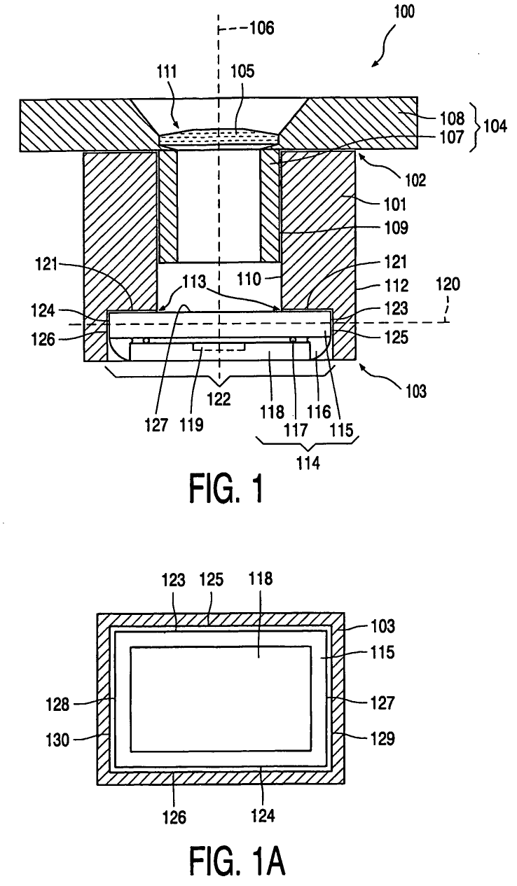

FIG. 1 is a sectional view of an embodiment of a camera module according to the invention;

FIG. 1A is a plan view of the camera module of FIG. 1;

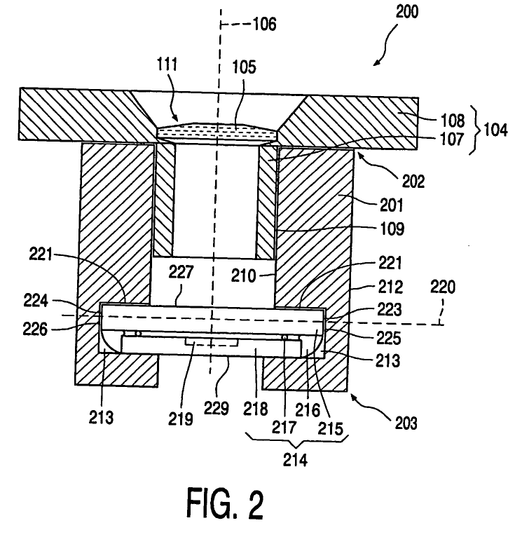

FIG. 2 is a sectional view of another embodiment of the camera module according to the invention;

FIG. 2A is a cross-sectional view of the camera module of FIG. 2; and

FIG. 2B is a plan view of the camera module of FIG. 2.

In the figures, like parts are indicated by the same numerals.

FIG. 1 is a sectional view of an embodiment of a camera module according to the invention. The embodiment of the camera module 100 that is shown therein comprises a holder 101. The holder is substantially configured as a hollow cylinder having a first end 102 and a second end 103. In the holder 101, a barrel 104 containing a lens 105 having an optical axis 106 is positioned near said first end 102.

The barrel comprises a hollow, cylindrical first part 107 which extends into the holder and a disc-shaped second part 108 having a central opening 111, in which the lens 105 is positioned. The diameter of the outer side 109 of the first part 107 and the diameter of the inner side 110 of the holder are geared to each other, so that the barrel 104 can be placed in the holder substantially without play in a direction perpendicular to the optical axis. The central axis of the second part coincides with the optical axis 106. The disc-shaped second part containing the lens 105 is positioned outside the holder 101. Since the second part 108 has a diameter which is larger than the diameter of the outer part 112 of the holder 101, it is simple to place the barrel 104 into abutment with the first end 102 so as to fix the holder 101 and the barrel in position relative to each other in the direction parallel to the optical axis 106 in this way. In the illustrated embodiment, both the holder 101 and the barrel 104 are made of a suitably selected plastic, for example . . . LCP (Liquid Crystal Polymer). Upon manufacture, the barrel 104 is slid into the holder 101. The two can be fixed together inter alia by means of a glue, for example Epotec H35 (low outgassing adhesive) or by laser welding.

It is also possible to use a system of lenses instead of the single lens 106 that is shown. This may be advantageous because the height of the camera module can be reduced in this way. Furthermore, the inner side 110 of the holder may be provided with an internal screw thread, and the outer side 109 of the first part 107 of the barrel may be provided with an external screw thread that fits therein. This makes it possible to adjust the distance between the lens 105 and the image pickup module 114 individually for each camera module to be produced. The advantage of this is that corrections can be made, for example for any production tolerances. If the aforesaid screw thread is used, a smaller diameter can be selected for the second part 108 of the barrel, since the position of the holder 101 and the barrel 104 with respect to each other in the direction parallel to the optical axis 106 can be determined sufficiently precisely through the use of mating screw threads on the outer side 109 of the first part 107 of the barrel and the inner side 110 of the holder. Finally, the outer side 112 of the holder 101 may also be of rectangular cross-section, for example. This may be advantageous with a view to simplifying the manufacture of the holder 101.

A usual measure for the height, the dimension in a direction parallel to the optical axis 106 of the holder 101, is 4-8 mm. A usual measure for the diameter of the inner side 110 is 4-6 mm. A usual measure for the diameter of the outer side 112 is 6-8 mm. A usual measure for the internal diameter of the first part 107 of the barrel is . . . 3-5 mm. A usual measure for the diameter of the outer side 109 of the first part 107 of the barrel is 4-6 mm. A usual measure for the diameter of the second part 108 of the barrel is 5-8 mm. A usual measure for the height of the second part 108 of the barrel is 3-5 mm. A usual lens has a diameter of 3-5 mm, a focal distance of 3-5 mm, and it is made of an optical plastic, although glass is also a suitable material.

A recess 113 is formed in the wall of the holder 101 near the second end 103 of the holder 101. An image pickup module 114 is placed in the recess 113 substantially without play in a direction perpendicular to the optical axis 106. The image pickup module 114 comprises a solid-state image sensor 118 and a glass substrate 115.

The solid-state image sensor, a CCD image sensor or a CMOS image sensor, for example, is provided with an image section 119. The solid-state image sensor has a thickness of 100-700 micron, for example, and is rectangular in shape, having a length of 3.2-6 mm, for example, and a width which has been selected such that the image sensor is suitable for picking up images in the CIF, VGA or SVGA image formats. The substrate 115 has a thickness of about . . . 0.1-1.1 mm, for example, and is rectangular in shape, having a circumference larger than that of the solid-state image sensor 118. The solid-state image sensor 118 is connected to the substrate 115 by means of a flip-chip technique, using bumps 117, with the image section 119 facing towards the substrate 115. A dam or side-fill material 116 may be arranged along the sides of the solid-state image sensor 118, in abutment with the substrate 115. In this way it is possible to keep the space between the solid-state image sensor 118 and the substrate 115 clear of dust and particles.

In addition to mechanically connecting the solid-state image sensor 118 to the substrate 115, the bumps 117 also provide the electrical connection between the electronics present on the solid-state image sensor 118 and the metallization pattern (not shown in FIG. 1), which is formed on the side of the glass substrate 115 that faces towards the solid-state image sensor 119. The metallization pattern on the glass substrate 115 can be electrically connected, in a manner which is known per se, to a pattern of conductive tracks formed on a flexible foil, which latter pattern is also connected to the other electronics in the camera system of which the camera module forms part.

Once the image pickup module 114 has been placed in the recess 113, the solid-state image sensor 118 and the substrate 115, and thus the module as a whole, are oriented substantially parallel to a plane 120 perpendicular to the optical axis 106. The substrate 115 is positioned between the lens 105 and the solid-state image sensor 118. The recess 113 is rectangular in shape, seen in sectional view along the plane 120, as is shown in the plan view of FIG. 1A. The recess provides abutting surfaces 125 and 126, which abut the lateral surfaces 123 and 124. The recess further provides the abutting surfaces 129 and 130 that are shown in FIG. 1A, which abut two other lateral surfaces 127 and 128 (likewise shown in FIG. 1A), of the substrate 115, so that the image pickup module can be placed in the recess 113 substantially without play in a direction perpendicular to the optical axis 106. The camera module 114 can be fixed in position in the holder 101 by means of a known fixing method, for example by means of a suitably selected glue.

In order to simplify the placing of the camera module 114 in the holder 101, the recess 113 provides an opening 122 along which the camera module can be placed in the recess 113 in a direction parallel to the optical axis 106.

In order to further simplify the placing of the camera module 114 in the holder 101, the recess 113 is provided with an abutting surface 121 extending parallel to the surface 120. The occurrence of a tilt of the image pickup module with respect to the optical axis 106 is prevented in a simple manner by placing the side 127 of the substrate 115 that faces towards the lens 105 into abutment with the abutting surface 121. In practice, said tilt is an important factor as regards the image quality of the camera module. The smaller the tilt, the better the image quality will be.

FIG. 1A is a plan view of the camera module of FIG. 1. The plan view shows the camera module 100 as seen from the second end 103 of the holder 101. Of the image pickup module 114, only the solid-state image sensor 118 and the substrate 115 are shown. The lateral surfaces 123, 124, 127 and 128 of the rectangular substrate 115 abut the respective abutting surfaces 125, 126, 129 and 130 of the recess 118 in the holder 101 substantially without play. For the sake of clarity, the distances between the lateral surfaces 123, 124, 127 and 128 and the associated abutting surfaces 125, 126, 129 and 130 are not shown in the correct proportion but rather too large.

FIG. 2 is a sectional view of a further embodiment 200 of a camera module according to the invention. The embodiment of the camera module 200 as shown comprises a holder 201. The holder is substantially in the form of a hollow cylinder having a first end 202 and a second end 203. A barrel 104 containing a lens 105 having an optical axis 106 is positioned in the holder 201 near the first end 202 thereof.

The diameter of the outer side 109 of the first part 107 of the barrel 104 and the diameter of the inner side 210 of the holder are geared to each other, so that the barrel 104 can be placed in the holder substantially without play in a direction perpendicular to the optical axis. The central axis of the second part coincides with the optical axis 106. The disc-shaped second part containing the lens 105 is positioned outside the holder 201. Since the disc-shaped second part 108 has a diameter which is larger than the diameter of the outer part 212 of the holder 201, it is a simple to place the barrel 104 into abutment with the first end 202 so as to fix the holder 201 and the barrel in position relative to each other in the direction parallel to the optical axis 106 in this way. In the illustrated embodiment, both the holder 201 and the barrel 104 are made of a suitably selected plastic, for example . . . LCP. Upon manufacture, the barrel 104 is slid into the holder 201. The two can be fixed together inter alia by means of a glue, for example Epotec H35 or by laser welding.

A recess 213 is formed in the wall of the holder 201 near the second end 203 of the holder 201. An image pickup module 214 is placed in the recess 213 substantially without play in a direction perpendicular to the optical axis 106. The image pickup module 214 comprises a solid-state image sensor 218 and a glass substrate 215.

The solid-state image sensor, a CCD image sensor or a CMOS image sensor, for example, is provided with an image section 219. The solid-state image sensor is rectangular in shape. The substrate 215 is rectangular in shape, having a circumference larger than that of the solid-state image sensor 218. The solid-state image sensor 218 is connected to the substrate 215 by means of a flip-chip technique, using bumps 217, with the image section 219 facing towards the substrate 215. A dam or side-fill material 216 may be arranged along the sides of the solid-state image sensor 218, in abutment with the substrate 215. In this way it is possible to keep the space between the solid-state image sensor 218 and the substrate 215 clear of dust and particles.

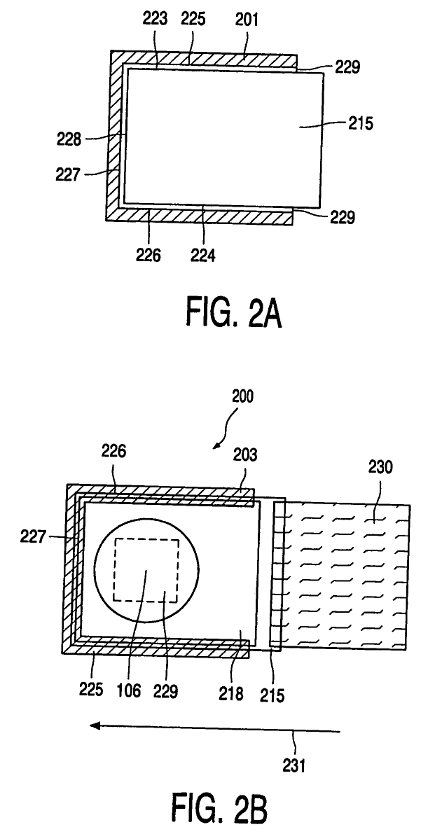

In addition to mechanically connecting the solid-state image sensor 218 to the substrate 215, the bumps 217 also provide the electrical connection between the electronics present on the solid-state image sensor 218 and the metallization pattern (not shown in FIG. 2), which is formed on the side of the glass substrate 215 that faces towards the solid-state image sensor 218. The metallization pattern on the substrate 215 can be electrically connected, in a manner which is known per se, to a pattern of conductive tracks formed on a flexible foil, which latter pattern is also connected to the other electronics in the camera system of which the camera module forms part. The positioning of the flex foil with respect to the substrate 215 will be further discussed in the description of FIG. 3.

Once the image pickup module 214 has been placed in the recess 213, the solid-state image sensor 218 and the substrate 215, and thus the module as a whole, are oriented substantially parallel to a plane 220 perpendicular to the optical axis 106. The substrate 215 is positioned between the lens 105 and the solid-state image sensor 218. The recess 213 is rectangular in shape, seen in sectional view along the plane 220, and one side has been left open for forming the lateral opening 229 in the wall of the holder that is shown in FIG. 2A. The recess provides abutting surfaces 225 and 226 extending perpendicularly to the plane 220, which are adapted as regards shape and dimension to abut on the lateral surfaces 223 and 224 of the substrate 225. The recess further provides an abutting surface 227 (shown in FIG. 2A) positioned opposite the lateral opening 229, which is adapted as regards shape and dimension to abut on the lateral surface 228 of the substrate 215 and which abuts on the abutting surfaces 225 and 226. This makes it possible to slide the image pickup module 216 into the recess 213 via said lateral opening from a direction perpendicular to the optical axis 106 until it abuts against the abutting surface 227, so that the image pickup module 214 is aligned with respect to the lens 106 in a plane perpendicular to the optical axis. The camera module 214 can be fixed in position in the holder 201 by means of a known fixing method, for example by means of a suitably selected glue.

In order to simplify the placing of the camera module 214 in the holder 201, the recess 213 may be provided with an abutting surface 221 extending parallel to the plane 220. The occurrence of a tilt of the image pickup module with respect to the optical axis 106 is prevented in a simple manner by placing the side 227 of the substrate 215 that faces towards the lens 105 into abutment with the abutting surface 121. In practice, said tilt is an important factor as regards the image quality of the camera module. The smaller the tilt, the better the image quality will be.

In order to further simplify the placing of the camera module 214 in the holder 201, the recess 213 may be provided with a second abutting surface 221 extending parallel to the plane 220 and facing towards the side 229 of the solid-state image sensor that faces towards the lens 105. The second abutting surface limits the amount of play in the direction parallel to the optical axis 106 in this way, thus making it easier to slide the image pickup module into the holder 201.

FIG. 2A is a cross-sectional view of the camera module of FIG. 2. The cross-sectional view has been taken along the plane 220 that is indicated in FIG. 2, it shows the substrate 215 after it has been placed in the recess 213. The lateral surfaces 223 and 224 of the long sides of the rectangular substrate 215 abut against the respective abutting surfaces 225 and 226 substantially without play. The lateral surface 228 of one of the short sides of the substrate 215 abuts against the abutting surface 227 that is positioned opposite the lateral opening 229 of the recess 213 via which the image pickup module 214 has been inserted.

FIG. 2B is a plan view of the camera module of FIG. 2. The plan view shows the camera module 200 as seen from the second end 203, with the image pickup module 214 being present in the recess 213. The figure shows a simplified view of the image pickup module, in which only the substrate 215 and the solid-state image sensor 218 are shown. The arrow 231 indicates the direction in which the image pickup module 214 is slid into the recess 213. The lateral surfaces 223 and 224 of the substrate 215 are longer than the respective abutting surface 225 and 226, as a result of which the substrate 215 partially extends outside the holder 201. The projecting part of the substrate 215 is kept clear in part with a view to affixing the flex-foil to 30 to the substrate. FIG. 2B also shows the position of the image section 219 relative to the inner wall 210 of the holder 201. The center of the image section 219 coincides with the optical axis 106.

The invention is not limited to the embodiments that are shown in the figures. A person of average skill in the art will arrive at alternative embodiments on the basis of the illustrated embodiments, which alternative embodiments are considered to fall within the scope of the invention.

The image pickup module 114 may also be of different construction. In the construction that is shown in FIG. 1, the substrate 115 is positioned between the lens 105 and the solid-state image sensor after being placed. According to another possibility, the solid-state image sensor is positioned between the substrate and the lens 105 after the image pickup module has been placed. In that case, the substrate might be made of a PCB material, for example, to which the solid-state image sensor is connected in a usual manner. Instead of using a flip-chip technique, the electrical connections between the circuits on the solid-state image sensor and the wiring patterns on the substrate could be effected by means of wire bonding. This may be advantageous for production reasons.

1. A camera module comprising a holder having a first end arranged for receiving incident light, a second end arranged for placing an image pickup module for picking up images, and a lens having an optical axis arranged for forming an image on the image pickup module, characterized in that the holder comprises aligning means near the second thereof for aligning the image pickup module in a plane perpendicular to the optical axis of the lens.

2. A camera module as claimed in claim 1, characterized in that the aligning means provide at least one recess near the second end, which recess extends parallel to a plane perpendicular to the optical axis and which is arranged for receiving the image pickup module substantially without play in a direction perpendicular to the optical axis.

3. A camera module as claimed in claim 2, characterized in that the recess has an opening via which the image pickup module can be placed in the recess from a direction parallel to the optical axis.

4. A camera module as claimed in claim 2, characterized in that the recess has a lateral opening via which the image pickup module can be placed in the recess from a direction parallel to the optical axis.

5. A camera module as claimed in claim 3, characterized in that the side wall is substantially rectangular in shape near the recess, seen in sectional view in a direction perpendicular to the optical axis.

6. A camera module as claimed in claim 3, characterized in that the image pickup module has a main surface oriented perpendicular to the optical axis and at least one lateral surface oriented substantially perpendicular to said main surface, the recess being configured to abut said lateral surface at least in part, substantially without play, after the image pickup module has been placed in the holder.

7. A camera module as claimed in claim 3, characterized in that said main surface comprises an edge on a side facing towards the lens, the recess being configured to abut said edge at least in part, substantially without play, after the image pickup module has been placed in the holder near said edge.

8. A camera module as claimed in claim 3, characterized in that the image pickup module has a second main surface comprising a second edge on a side facing away from the lens, the recess being configured to abut said second edge at least in part, substantially without play, after the image pickup module has been placed in the holder near said second edge.

9. A camera system comprising a camera module, characterized in that said camera module is the camera module as claimed in any one of the claims.

10. A method of manufacturing a camera module comprising a holder having a first end arranged for receiving incident light, a second end arranged for placing an image pickup module for picking up images, and a lens having an optical axis arranged for forming an image on the image pickup module, characterized in that the method comprises a step in which the image pickup module is aligned with respect to the optical means in a direction perpendicular to the optical axis, using aligning means disposed near said second end.
